(19) United States
(12) Patent Application Publication
(10) Pub. No.: US 2016/0081781 A1
(43) Pub. Date: Mar. 24, 2016

(54) Method to reduce or eliminate breath odors and aftertaste by inserting an apparatus into the mouth

(71) Applicant: Kathleen Diane Bosak, Canyon Country, CA (US)

(72) Inventor: Kathleen Diane Bosak, Canyon Country, CA (US)

(21) Appl. No.: 14/493,358

(22) Filed: Sep. 23, 2014

(51) Int. Cl. A61C 19/06

(52) U.S. Cl. CPC A61C 19/06

(57) ABSTRACT

A stainless steel apparatus with edges to enable the users teeth to hold in place. The metal is processed by an electropolishing passivation process to make it stronger and more effective. The edges are coated with a non toxic plastic coating which may or may not contain a stainless steel mixed plastic. Various sizes and shapes can be used to make the apparatus.

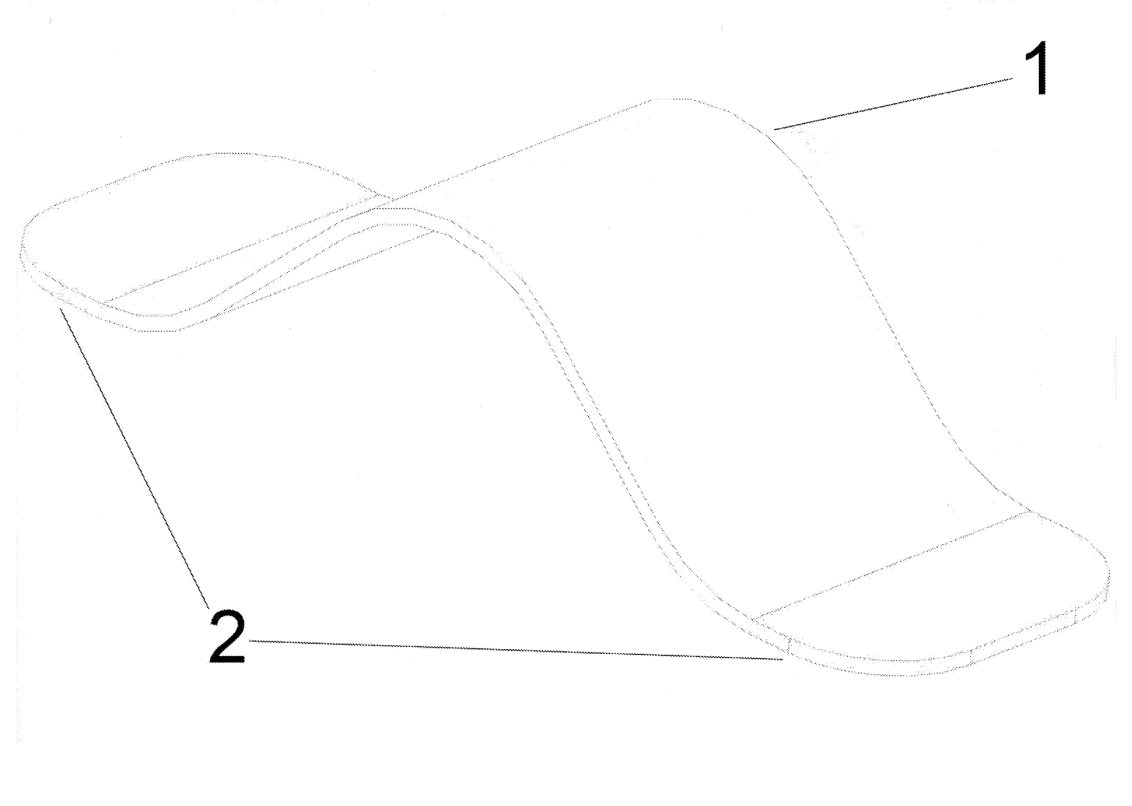

### BACKGROUND OF INVENTION

“Bad breath” and “Aftertaste” are common, unpleasant and annoying problems that have plagued people for centuries. Daily interactions such as business meetings, dating, and everyday contact with people can make this an embarrassing almost helpless situation. When at a restaurant during a business meeting, date or with friends you avoid your favorite foods so you do not offend them

Oral care products focus on trying to make your breath fresh, but carrying around toothpaste, mouthwash or toothbrush is very inconvenient and impractical. Gums, mints and sprays get expensive to buy all the time and all of these products do not address the problem, but only poorly try to mask the problem.

Common products available today are unable to actually address the source of the problem or able to reduce or eliminate aftertaste, pasty tongue, morning breath, or breath odors. The problem can run deep into the digestive system of your stomach, many odors come from the stomach from what has been consumed through saliva and burping. The oral products available today cannot address the stomach contents.

The oral industry offers several products to help control bad breath. Mints seem like a quick fix, but mints can only mask odor for a short time and not address the long lasting effects desired. You find yourself spending more money on another pack of mints which gets costly and inconvenient.

Mouthwash is a common product used to address breath odor, but does not address aftertaste. The effect is a short term masking and is an inconvenient product to carry with you and use. The process of carrying a bottle of mouthwash with you, gargling it and needing a sink to expel the contents is impractical, short term and gets expensive to keep buying.

Toothpaste is very important to clean your teeth and gums, but is short acting and you must carry a toothbrush and tube of toothpaste with you all the time, especially during a business meeting, date or at a restaurant with friends. The process of brushing and rinsing in a public place is impossible or near impossible to do. The embarrassment of brushing and spitting in the public arena deters people from choosing this option. Toothpaste does not address aftertaste after brushing and rinsing.

Gum comes in many flavors, but you have to continually chew it and it rapidly looses it's flavor and scent. The gum tries to mask the bad breath, but it does a poor job of being effective and again is short acting and does not address aftertaste. You find yourself buying gum everywhere you stop and sometimes run out at the wrong time, this also gets costly.

Drops or sprays are a cross between mouthwash and mints and can help with some bad breath, but at a superficial and short term result. Drops and sprays still do not address aftertaste or the problem itself. These products also have to be replenished and becomes costly.

The apparatus can be used as often as necessary or desired by the user, it can be used quickly and discreetly. The user will notice a significant reduction and/or elimination of human breath odor and /or aftertaste. The user may not be able to taste or smell what they have consumed even when they burp. The effects may last for hours or until they consume again. The more often the apparatus is used the better the long term effects can occur. This apparatus is reusable, cost effective and environmentally friendly.

### FIELD OF INVENTION

This invention relates to an apparatus and method the user may there by decrease or eliminate the odor and/or aftertaste of human breath.

### SUMMARY OF INVENTION

The invention is a method of reducing and/or eliminating human breath odor and aftertaste. The method includes inserting an apparatus into the mouth and holding it in place with their teeth. The user then fills their mouth with water and vigorously swishes the water in the mouth and swallows the contents. When finished removing the apparatus from the mouth.

### BRIEF DESCRIPTION OF THE DRAWINGS

Point 1 is a representation of the form of apparatus for controlling unpleasant human breath odors and aftertaste, it is a self contained, insertable, breath refreshing apparatus

Point 2 is a representation of the coating that may be dipped onto the apparatus on the flanges of the self contained, insertable, breath refreshing apparatus

### DETAILED DESCRIPTION FOR DRAWINGS

The apparatus is a self contained, portable, insertable apparatus which can be used as often as desired. The apparatus is a convenient size to fit into the mouth easily to rinse with water. The user simply swallows the contents eliminating the need to spit it out

Point 2 demonstrates the flanges that may have a mixed plain plastic nontoxic dip added to them for comfort in the mouth

1. An apparatus for refreshing unpleasant human breath odor, aftertaste, pasty tongue, and dental appliance taste and odor.

2. An apparatus for refreshing unpleasant human breath odor, aftertaste, pasty tongue, morning breath, garlic/onion breath, tobacco flavor, and dental appliance taste and odor. The method comprising the step of: an apparatus inserted and held in the mouth with the users teeth, filling the mouth with water and vigorously swishing followed by swallowing the contents. The apparatus is then removed from the mouth by the user.

3. An apparatus for refreshing unpleasant human breath odor. The method comprising the step of: an apparatus inserted and held in the mouth with the users teeth, filling the mouth with water and vigorously swishing followed by swallowing the contents. The apparatus is then removed from the mouth by the user.

4. An apparatus for refreshing aftertaste according to claim 1. The method comprising the step of: an apparatus inserted and held in the mouth with the users teeth, filling the mouth with water and vigorously swishing followed by swallowing the contents. The apparatus is then removed from the mouth by the user.

5. An apparatus for refreshing pasty tongue according to claim 1. The method comprising the step of: an apparatus inserted and held in the mouth with the users teeth, filling the mouth with water and vigorously swishing followed by swallowing the contents. The apparatus is then removed from the mouth by the user.

6. An apparatus for refreshing morning breath according to claim 1. The method comprising the step of: an apparatus inserted and held in the mouth with the users teeth, filling the mouth with water and vigorously swishing followed by swallowing the contents. The apparatus is then removed from the mouth by the user.

7. An apparatus for refreshing garlic breath according to claim 1. The method comprising the step of: an apparatus inserted and held in the mouth with the users teeth, filling the mouth with water and vigorously swishing followed by swallowing the contents. The apparatus is then removed from the mouth by the user.

8. An apparatus for refreshing onion breath according to claim 1. The method comprising the step of: an apparatus inserted and held in the mouth with the users teeth, filling the mouth with water and vigorously swishing followed by swallowing the contents. The apparatus is then removed from the mouth by the user.

9. An apparatus for refreshing tobacco flavor according to claim 1. The method comprising the step of: an apparatus inserted and held in the mouth with the users teeth, filling the mouth with water and vigorously swishing followed by swallowing the contents. The apparatus is then removed from the mouth by the user.

10. An apparatus for refreshing dental appliance flavor according to claim 1. The method comprising the step of: an apparatus inserted and held in the mouth with the users teeth, filling the mouth with water and vigorously swishing followed by swallowing the contents. The apparatus is then removed from the mouth by the user.
